(19) United States
(12) Patent Application Publication
(10) Pub. No.: US 2016/0335551 A1
(43) Pub. Date: Nov. 17, 2016

(54) OPTIMIZATION OF FRAUD DETECTION STRATEGIES

(71) Applicant: SAP SE, Walldorf (DE)

(72) Inventors: Sebastian Droll, Bruchsal (DE); Manfred Preissendoerfer, Hockenheim (DE); Ilijana Christov, Walldorf (DE); Martin Erdelmeier, Schifferstadt (DE); Moritz Heipe, Karlsruhe (DE); Heinrich Braun, Ettlingen (DE); Christian Gschloessl, Wiesloch (DE); Kay Hammerl, St. Leon-Rot (DE); Eric Berettoni, Wiesloch (DE); Rainer Walter Fellmeth, Wiesloch (DE)

(73) Assignee: SAP SE, Walldorf (DE)

(21) Appl. No.: 14/710,463

(22) Filed: May 12, 2015

(51) Int. Cl. G06N 5/04; G06N 3/12

(52) U.S. Cl. CPC G06N 5/046; G06N 3/126

(57) ABSTRACT

A computer-implemented fraud detection system comprises a processor and memory storing computer-readable instructions for causing a computer to perform a method for determining potentially fraudulent records. The method performed by the computer comprises executing a trial fraud detection strategy routine on historic records in a database, the trial detection strategy comprising multiple rules including at least one weighting factor. The method further includes calculating an efficiency of the trial fraud detection strategy based on the multiple rules and executing an iterative routine to optimize adjusting the at least one weighting factor. An adjusted fraud detection strategy that incorporates the adjusted weighting factor is set.

### BACKGROUND

Detecting fraud continues to be an important function for business, government and other enterprises. As such enterprises rely more and more on transacting business electronically and keeping electronic records, there is an ongoing need to provide better tools adapted to interact with the varied software and data storage systems in use today.

Fraud detection includes real time detection, such as in connection with fraudulent on-line transactions, as well as investigation of potential fraud as evidenced in database records that exhibit specific characteristics. In many cases, at least a part of the investigation takes place after the fraud has occurred. An investigator, such as an employee of the enterprise or an outside investigator hired by the enterprise, reviews the enterprise's existing records to determine suspicious data, patterns associated with fraud and/or other indicators of fraudulent activity. If such investigation yields helpful results, such as through a process to confirm suspicious data attributes based on known cases of fraud in the existing records, then the same or similar methodology can be employed to investigate current records of ongoing activity.

Presently available tools for investigators fall short of providing effective assistance.

### SUMMARY

Described below are approaches to improving fraud detection strategies.

According to a method implementation, a computer-implemented fraud detection method for determining potentially fraudulent records in a database comprises executing a trial fraud detection strategy routine on historic records in the database, the trial detection strategy comprising multiple rules, calculating a number of the historic records determined to be proven fraud records according to the trial fraud detection strategy, calculating a number of the historic records determined to be false positive records according to the trial fraud detection strategy, calculating a trial efficiency of the trial fraud detection strategy based on a difference between a number of determined proven fraud records multiplied by a profit factor for each proven fraud record and a number of determined false positive records multiplied by a cost factor for each false positive record and determining an adjusted fraud detection strategy with an efficiency that equals or exceeds the trial efficiency.

In some implementations, at least one of the multiple rules has a respective weighting factor, and determining an adjusted fraud detection strategy comprises optimizing a weighting factor for the at least one of the multiple rules.

In some implementations, the multiple rules have respective weighting factors, and wherein determining an adjusted fraud detection strategy comprises using a genetic solution approach to determine adjusted weighting factors for the multiple rules such that the rules are weighted relative to each other differently in the adjusted fraud detection strategy than in the trial fraud detection strategy.

In some implementations, the genetic solution approach comprises selecting five child solutions derived by mutation from three parent solutions, and selecting next parents from the child solutions. In some implementations, the genetic solution approach is iterated at least three times in determining the adjusted fraud detection strategy.

In some implementations, the trial fraud detection strategy is executed once, and wherein determining an adjusted fraud detection strategy comprises selecting subsets of the results from the trial fraud detection strategy results and weighting each selected subset according to a predetermined method.

The foregoing and other objects, features, and advantages will become more apparent from the following detailed description, which proceeds with reference to the accompanying figures.

### BRIEF DESCRIPTION OF THE DRAWINGS

FIG. 1 is a flow chart of a method according to one implementation for increasing the efficiency of a fraud detection routine.

FIG. 2 is a flow chart of a method according to another implementation for increasing the efficiency of a fraud detection routine.

FIG. 3 is an exemplary functional block diagram of a system for fraud detection.

FIG. 4 is an explanatory diagram for the fraud detection methods and systems.

FIG. 5 is a drawing showing a graphical user interface reporting results of a first simulated fraud detection strategy.

FIG. 6 is a drawing showing an updated graphical user interface with results of a second simulated fraud detection strategy (left) compared to results of the first fraud detection strategy (right).

FIG. 7 is a drawing of a graphical user interface in which the user is prompted to enter factors for optimizing the fraud detection strategy.

FIG. 8 is a drawing illustrating how a genetic algorithm is applied to optimizing the fraud detection strategy.

FIG. 9 is a graph showing representative fitness functions.

FIGS. 10A and 10B are schematic graphs of a fitness function as applied to determine proven fraud instances and false positive instances.

FIG. 11 is a graph showing convergence to a solution according to one implementation.

FIG. 12 is a diagram of an exemplary computing environment in which the described methods and systems can be implemented.

### DETAILED DESCRIPTION

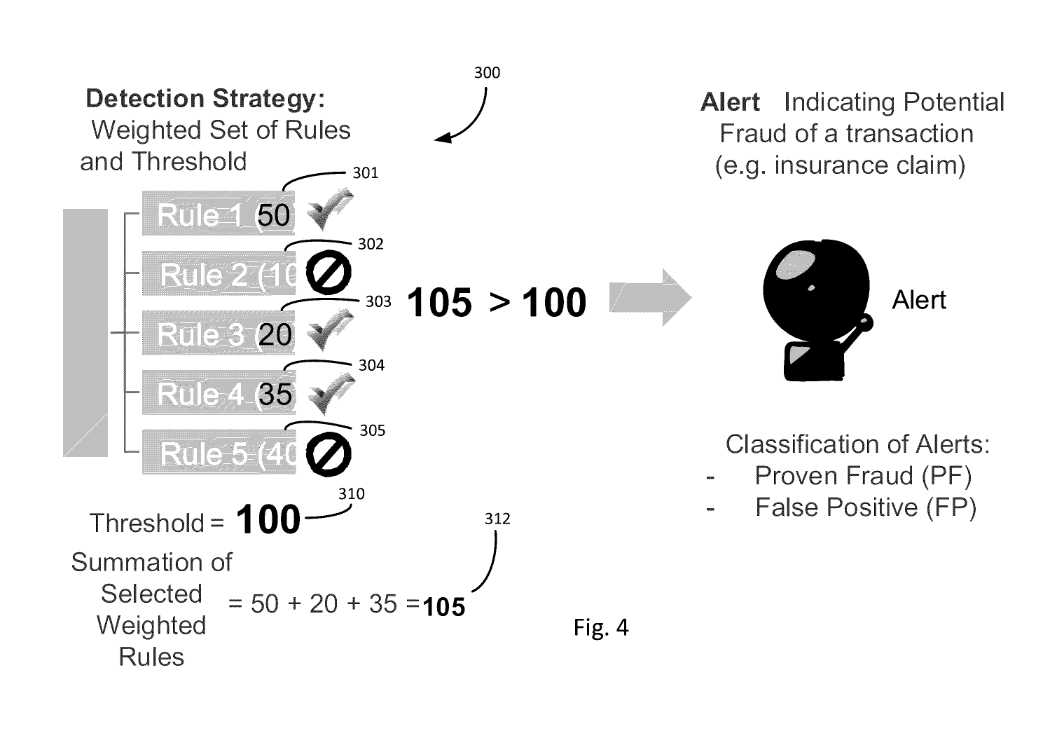

FIG. 4 is a diagram explaining how a conventional fraud detection system is used to review database records and determine a selected set of records relating to potentially fraudulent activity. The selected set of records may be determined according to multiple factors, including the number of included records. Once identified to one or more users, the selected set of records can be subjected to further review, which could include subsequent filtering or other techniques to refine the selected set of records and/or a human review of events represented by the records.

The number of included records in the selected set, also called the threshold, can be set by a user of the system. For example, the user can set the threshold according to available resources, e.g., how much time of her time can be allotted to a review of the selected set of records. Other factors could also be taken into account.

Referring to FIG. 4, an exemplary fraud detection strategy, which in this case can also be referred to as a trial fraud detection strategy 300, is shown schematically. The trial fraud detection strategy 300 is based on a combination of five parameters, also referred to as rules (Rule 1, Rule 2, Rule 3, Rule 4 and Rule 5), which are identified as 301, 302, 303, 304 and 305, respectively. The respective weighting factors for the rules are shown in parentheses following each rule, i.e., “50,” “10,” “20,” “35” and “40”.

In the example of FIG. 4, there is a database record that satisfies Rules 1, 3 and 4, but does not satisfy Rules 2 and 5. For each such rule that is satisfied, the number 100 is associated to the database record (i.e., it is a “hit”). Thus, for the sake of illustration, we can assume a specific database record (e.g., record 4711) is examined by Rules 1 to 5 with the following results: Rule 1—100, Rule 2—0, Rule 3—100, Rule 4—100, and Rule 5—0.

Later in the program, each of these results is divided by 100 and then multiplied by its respective weighting factor, resulting in a “rule-score of the record,” sometimes also referred to as a “weighted rule.” For the specific example, the individual rule-scores are as follows: for Rule 1—100/100×50=50, for Rule 2—0/100×10=0, for Rule 3—100/100×20=20, for Rule 4—100/100×35=35 and for Rule 5—0/100×40=0.

A Total Score 312 is determined by summing up all of the individual rule-scores of those rules that hit this record. In the example of FIG. 4, the Total Score for the database record of interest is 105, which is the summation of the individual rule-scores for Rules 1, 3 and 4 (50+20+35=105). Because the Total Score (105) exceeds a predetermined threshold 310 (i.e., 100 in this example), it is deemed suspicious an alert is triggered.

It can be difficult, tedious and time consuming for the user to keep modifying which rules to include in the strategy and adjusting the respective weighting factors as she seeks to define a selected set of records for further action. In many cases, the user is interacting with the database as a business person and not as a database specialist who may have specific knowledge in how to search and/or filter records in alternative ways.

### Example

### Exemplary Fraud Detection in Motor Vehicle Insurance Claims

According to a new approach, the systems and methods described herein use one or more parameters that are optimized so as to yield the desired results without requiring repeated user interaction. For example, the user need not repeatedly adjust which rules to include in the detection strategy and/or their respective weighting factors. Rather, the systems and methods use factors to solve a complex problem iteratively and achieve an optimized solution automatically. The factors can be selected to define important criteria for the domain to which the records relate. The user can be prompted to supply the factors (generally, there are at least two), or they can be accessed in other ways.

In the example of fraud detection in motor vehicle insurance claims (accidents), the factors may include a profit factor and a cost factor. The profit factor can be defined as the profit that the insurer historically realized on average following the investigation and settlement of each record in which fraud was proven to have occurred. The cost factor can be defined as the cost that the insurer has incurred for investigating each record that was thought to relate to fraudulent activity but in fact turns out to be non-fraudulent. The profit and cost factors are well known to business functions and business people who are concerned with fraud detection. In other domains, different factors can be selected.

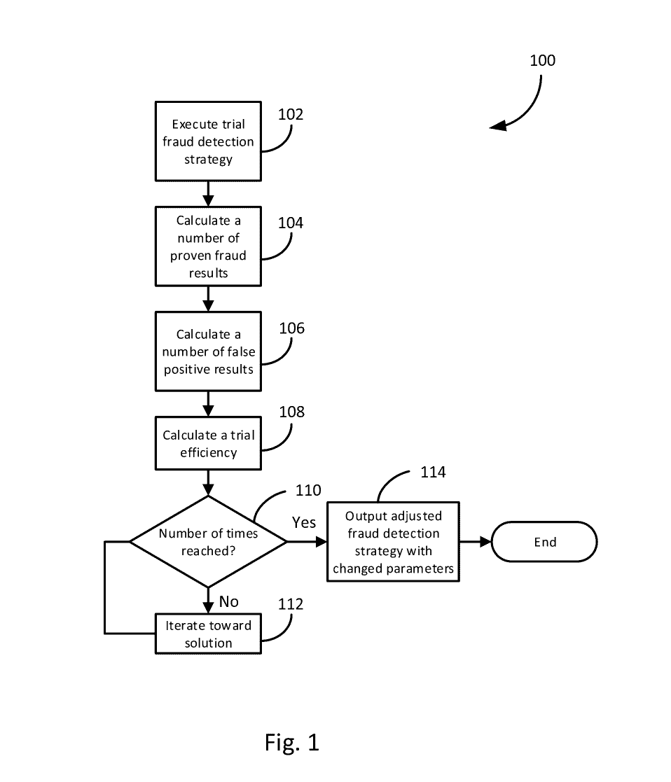

FIG. 1 is a flow chart showing steps of an exemplary method 100. In step 102, a trial detection strategy is executed. The trial detection strategy has multiple rules that have been set, such as by the user. In the domain of motor vehicle insurance claims, possible rules include (1) claims involving drivers ages 18-25, (2) claims involving damage in excess of $10,000, (3) claims involving accidents occurring at nighttime, as just some examples.

In step 104, the number of proven fraud results determined from executing the trial detection strategy is calculated. Similarly, in step 106, the number of false positive results determined from executing the trial detection strategy is calculated. In step 108, a trial efficiency is calculated. In this step, the influence of the factors is calculated. In the domain of motor vehicle insurance claims and knowing profit and cost factors and the numbers of proven fraud and false positive results, the trial efficiency is equal to the number of proven fraud results multiplied by the profit factor, minus the number of false positive results multiplied by the cost factor.

In step 110, it is determined whether a predetermined number of times or other constraint on the iterative process has been reached. If not, then in step 112 another iteration towards the solution is completed, and the process returns to step 110. Once the predetermined number of times (or other constraint) has been reached, then in step 114 an adjusted fraud detection strategy with changed parameters is output.

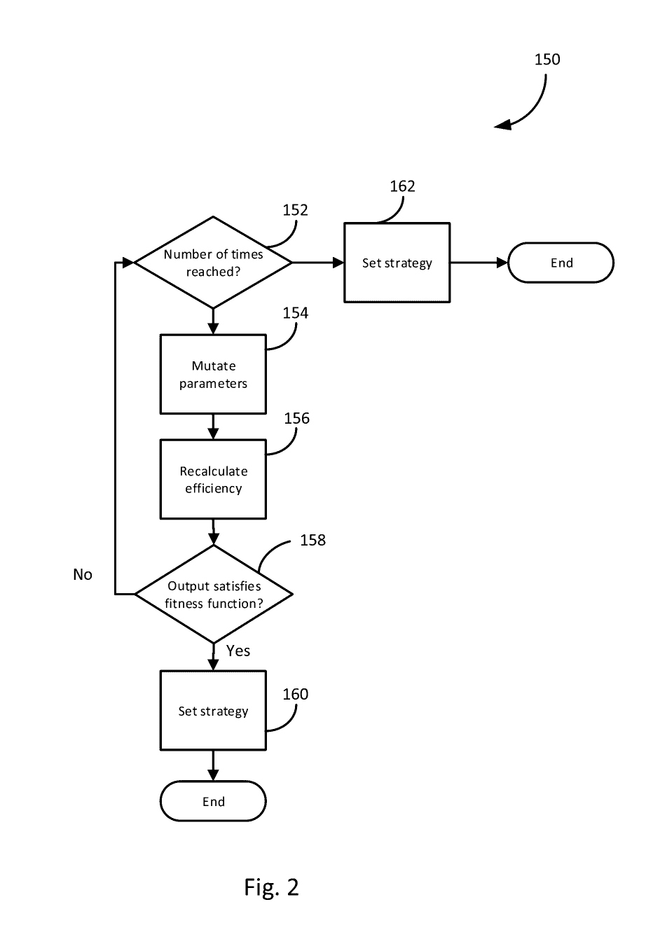

FIG. 2 is a flow chart showing steps of another exemplary method 150. In step 152, it is determined whether a predetermined number of times (or other constraint) has been reached. If not, then the process using the factors to optimize the results begins. In step 154, a genetic algorithm is used in optimizing the results, and parameters are subjected to a mutation to yield new parameters. In step 156, the efficiency is recalculated. In step 158, it is determined whether the output satisfied the fitness function.

If not, then the process returns to step 152. If the predetermined number of times has been reached, then the strategy is set in step 162. If the predetermined number of times has not been met, then the process continues with another mutation (step 154) and recalculating the efficiency (step 156). If the output now satisfies the fitness function, then the strategy is set (step 160) and the process is concluded.

### Example

### Functional Block Diagram

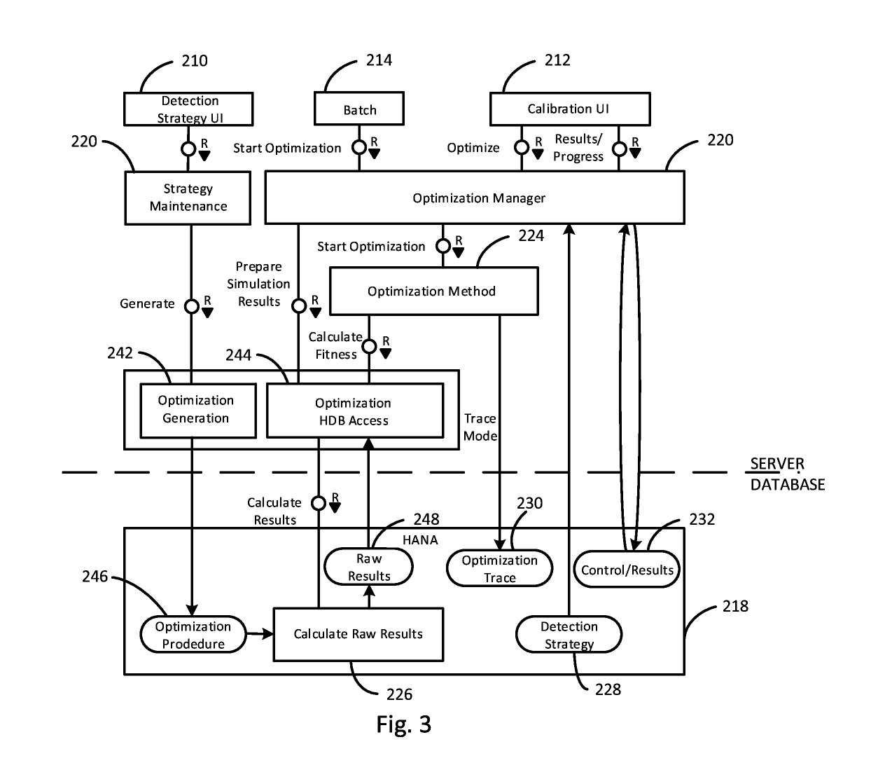

FIG. 3 is a functional block diagram of major components of a system 200 for fraud detection according to one implementation. FIG. 3 shows components of the program, how they interact and the flow of selected calls in the program.

The first component 210 is a user interface component, which can implement a user interface for a desktop environment or for a mobile device environment (usable with smart phones, tablets and other types of mobile devices). The user interface can be implemented in HTML 5 or in any other suitable computing language/platform. The first component 210 reads detection strategies and detection method assignments from a strategy maintenance component 220.

A batch component 214 represents a background or “batch” job that is initiated upon pressing the “Start Optimization” button that orchestrates, with the optimization manager 222 described below, multiple iterations of the calculation of the fitness function (described below in greater detail) to provide optimal weighting factors for the strategy in question.

There is a calibration UI component 212 that can implement a calibration user interface. The calibration user interface presents the user with one or more parameters (also called “rules”) making up a detection strategy. The calibration user interface allows the user to modify at least one parameter, and thus to modify the corresponding detection strategy.

There is an optimization manager component 222 that controls optimization, including implementing three user interfaces that provide different functionality, depending on whether the optimization manager is called from the user side or internally from a background process. From a user's point view, the optimization run needs to be started and/or canceled, and the results have to be retrieved. This is done on the OData side by calling the interface IF_FRA_OPT_MANAGER_CONSUMER, described below in connection with the optimization method component 224.

The optimization method component 224 executes the optimization method, which can implemented as a genetic algorithm, as one example. The optimization method is called by the standardized optimization interface. The actual optimization run is triggered in the background job via a second interface IF_FRA_OPT_MANAGER method OPTIMIZE_WEIGHTING_FACTORS within the report FRA_DS_OPTIMIZATION.

The following steps are performed: check if optimistic lock for detection strategy is met; check if the user is allowed to calibrate; read the detection method assignments persisted on strategy level (not used from UI); set a first progress indicator for the run; calculate the raw detection results 226 by DB access instance of type IF_FRA_OPT_DB_ACCESS, thereby the parameter values from the UI are passed and taken into account for the raw results calculation; unlock the detection strategy 228; set the second progress indicator for the run; start the execution of the genetic algorithm, thereby the profit and cost factors from the UI as well as the threshold and the read detection method assignments are passed.

Optimization Trace 230 and Trace Mode refer to functionality implemented to allow the system to trace intermediate calculation results, i.e., to save them in a database table, by setting specific parameters (Set/Get-parameters) in order to fine tune the optimization algorithm. This tracing functionality is generally switched off in a “production” environment as it can reduce the performance of the optimization.

A Control/Results functionality 232 refers to a database table that is used to control flow of the program.

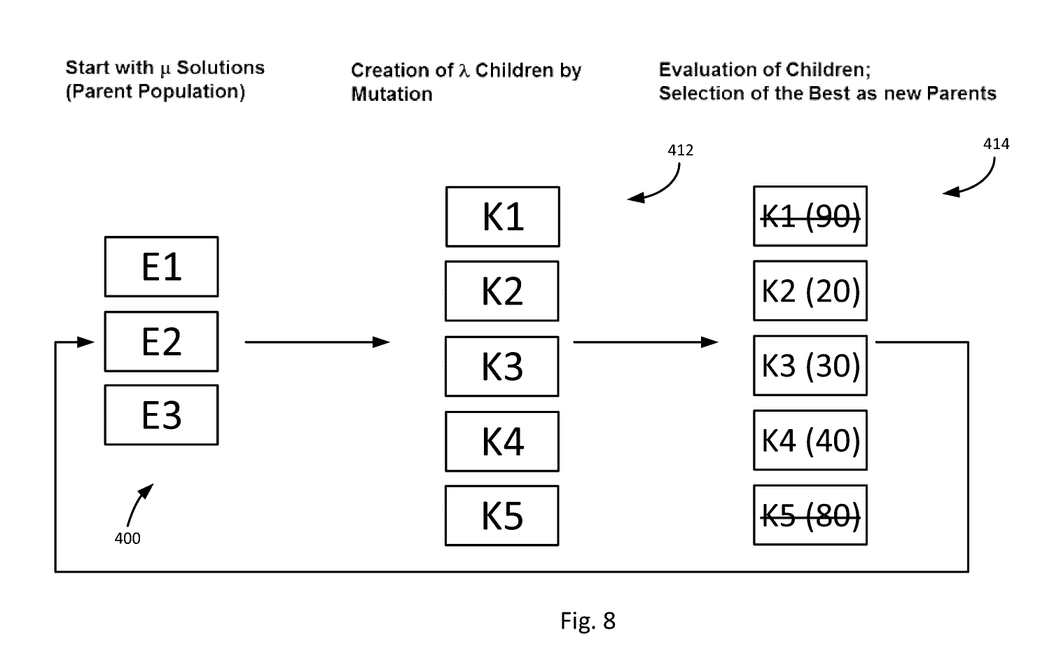

An Optimization Database Access component 244 manages a lifecycle of the connection to a database 218. “Proxy to raw optimization mass data kept in” the database 218 triggers parallel calculation of raw optimization data in the database into a raw results temporary table 248. In addition, the optimization database access component 244 triggers parallel calculation of a fitness function based on raw results in the database for an optimization method, such as a genetic algorithm. In some implementations, the parallel calculation of the fitness function occurs only once “for all beings of a generation.” “Beings” (i.e., parents, children) in this context are “sets of weighting factors.” Thus, {50, 10, 20, 35, 40} is a set of five weighting factors for the five rules of a given strategy. If the algorithm creates (randomly), say six sets of weighting factors (corresponding to five “children-beings”), it then is able to calculate in parallel the five “fitness-values” for these beings, using the implemented parameterizable fitness-function. The three “fittest” (according to the fitness-value ordering) are promoted to “parent-beings” (see FIG. 8).

In some implementations, mass data is kept in the database and processed in parallel. Only highly aggregated results are passed from the database to the server. In this way, response time is improved and the optimization can be integrated into a dialog user interface. In this way, “heavy” work, i.e. data processing of large amounts of data, is done by the database, as opposed to first transferring those large amounts of data from the database to the application server in order to process it on the server in a non-optimized way. The server cannot complete the heavy work as quickly as the database because the server is designed in a database-agnostic way. Data aggregation leads to smaller data chunks that do not take much time to be transferred from the database to the server, so that it is possible to see the results of the processing in real time, i.e. during a dialog transaction.

An optimization generation component 242 generates a detection strategy suited for the database 218 to calculate the raw optimization data based on the defined rules. The optimization procedure 246 is a generated database procedure for each detection strategy. The output of the optimization procedure is a temporary table of raw results that is iteratively used by the optimization algorithm.

Once the execution of the genetic algorithm has finished, the optimized weighting factors are stored in the database table FRA_D_OPT_DMA (implemented in 232) and the status and progress of the run in table FRA_D_OPT_RESULT (also implemented in 232) are set to “finished” and “100%,” respectively. Additionally, the previously passed detection method parameters are deleted from table FRA_D_OPT_DMPAR.

The third interface implemented by the optimization manager component 222 is IF_FRA_OPT_MANAGER_INT which offers the method SET_OPTIMIZATION_RESULT. It is used by the genetic algorithm to update the progress of the algorithm in relation to the overall optimization progress within table FRA_D_OPT_RESULT.

### Example

### Optimization with Genetic Algorithm

FIGS. 4-6 relate to an example where the system and methods are implemented to detect fraud by examining database records representing automobile insurance claims.

FIG. 4 is a drawing of an exemplary user interface 300 used to report results to a user when a trial fraud detection strategy is completed. The process of running a trial strategy is also referred to as “simulation” or “calibration.” As shown in FIG. 4, a report element 302 shows that for a first simulation (“Simulation: 1”), the trial detection strategy was applied against 35,802 database records containing known historic data, covering the period from Apr. 1, 2010 to Mar. 3, 2013. According to the results, there are 540 “Proven Fraud” records relating to cases of proven fraud and about “19K” “False Positive” records (19,109 records actual) relating to cases that appeared to be fraudulent initially but were later determined, generally after investigation, to be non-fraudulent. As a result, the efficiency of this strategy is calculated as 3% (540/1909×100) and is displayed in the interface. In addition, the interface indicates that none of the records were unclassified, and there are no new alert items. An action element 304 allows the user to select commands such as “Start Simulation,” “Find Best Values,” and “Save,” as just three examples.

Assuming that the average savings or profit per Proven Fraud record is 3200 [symbol] (i.e., a profit factor kProfit of 3200 [symbol] ), and that the average cost per False Positive record is 80 [symbol] (i.e., a cost factor kCost of 80 [symbol] ), then a baseline result for the potential value of the first simulation can be calculated as follows:

PF*kProfit−FP*kCost=540*3200 [symbol] −19,109*80 [symbol] =199,280

[symbol]

Based on the results shown in FIG. 4, particularly the low efficiency, a business person using the system could rationally decide that the trial strategy should be improved so that more Proven Fraud records and fewer False Positive records are found, thus increasing the potential value.

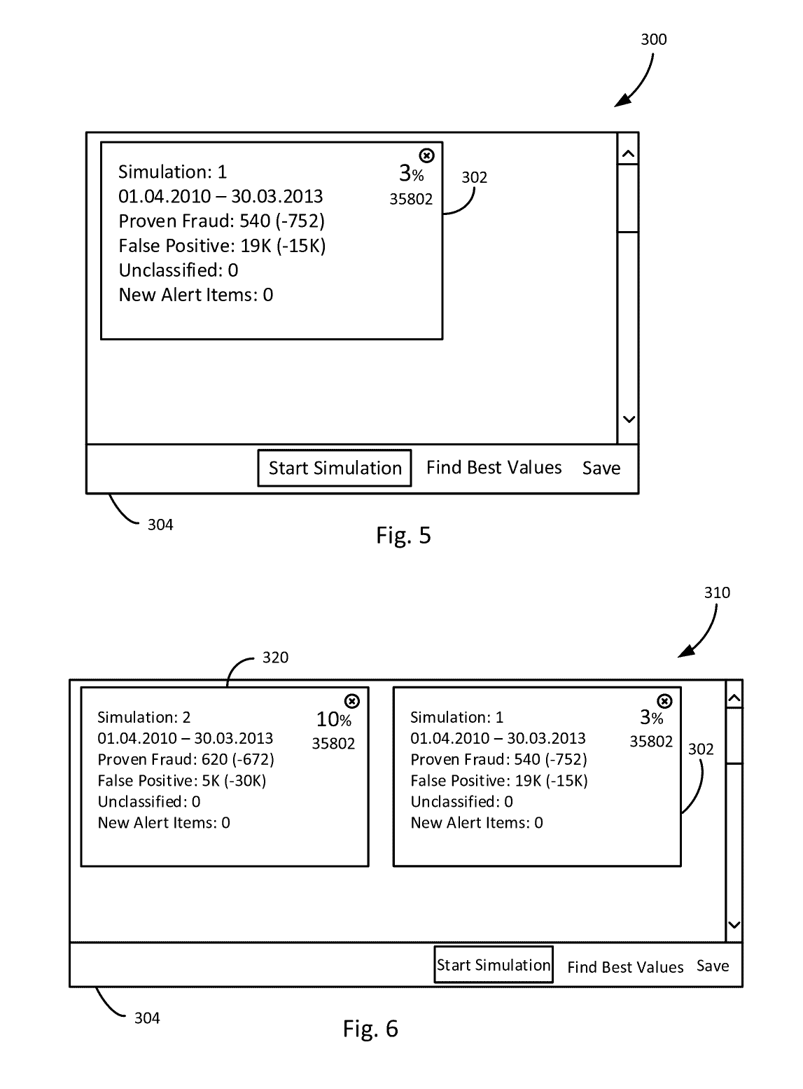

FIG. 5 is a drawing of another user interface element 310 showing the report element 304 and the action element 304 of FIG. 4, together with a second report element 320. As shown in FIG. 5, in the second report element 320, the results of a second simulation (“Simulation: 2”) are shown next to the results for the first simulation. In the second simulation, which also covers the period from Apr. 1, 2010 to Mar. 30, 2013 and is run over the same 35,802 records, there are 620 Proven Fraud results and about “5K” False Positive results (4,746 records actual). As a result of the greater number of Proven Fraud results and especially the fewer number of False Positive results, the efficiency of the second simulation (10%) is much higher (i.e., a threefold increase over the 3% efficiency in the first simulation). The same calculation in FIG. 4 shows the dramatically greater potential value of the second simulation:

PF*kProfit−FP*kCost=620*3200 [symbol] −4,746*80 [symbol] =1,604,320

[symbol]

In the example of FIGS. 4 and 5, the system has executed a routine iteratively to reach a solution maximizing a function based on two or more factors provided to the system. In the example, the factors are the profit factor and the cost factor. In some implementations, the user is queried to enter the profit factor and the cost factor, such as through the exemplary user interface 350 shown in FIG. 6. In other implementations, the profit and cost factors may be accessed from memory and the user may be given an option to use the accessed factors or to propose new values for the factors.

In the example, a non-linear optimization problem is presented, and a best solution to the problem is generated automatically using an iterative process. According to one implementation, the iterative process is based on a genetic algorithm, but other optimization processes could also be used.

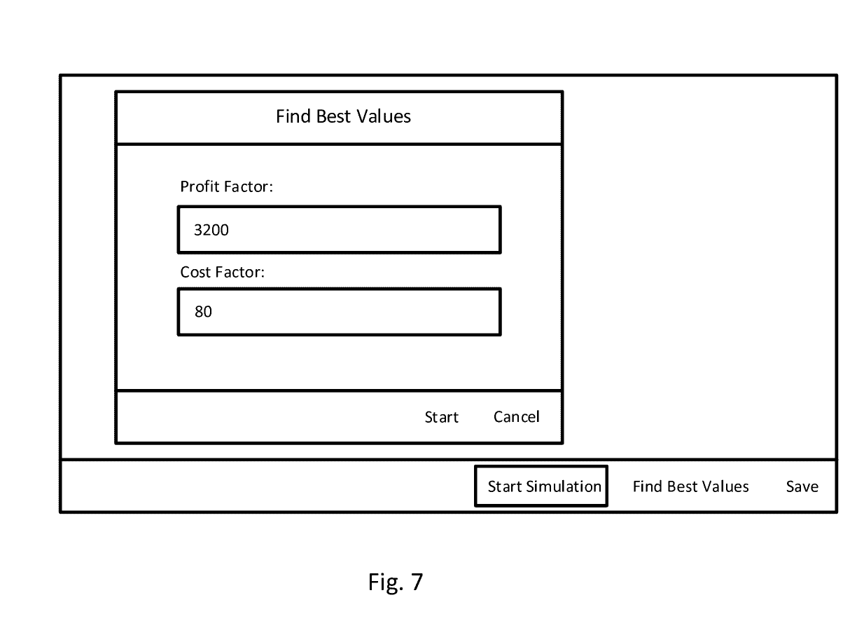

FIG. 7 is an explanatory diagram that shows the general approach used in a genetic algorithm. The principle of a generic algorithm is motivated by the evolution in nature. It is an iterative optimization approach which compares possible solutions with a fitness function against each other. According to one implementation for fraud management, the weighting factors for the rules of the detection strategy are adjusted based on the results of a genetic algorithm approach.

According to the approach, an initial population is defined. In FIG. 7, an initial or parent population 400 representing μ possible solutions is designated schematically by the members E1, E2 and E3. The parents are selected from the parent population. Next, a set of λ child solutions, i.e., children 412, are produced from the parents, such as by subjecting the parents to a mutation operation. In the illustrated example, the children 412 are K1, K2, K3, K4 and K5. The mutation operation adapts each weighting factor of a possible solution via a normal distributed random number and a given mutation interval. The quality of each child is evaluated via a fitness function, and the best μ children (i.e., the children K2, K3, K4) are selected as new parents for the next iteration.

The seed functionality of a random number generation routine is used to ensure stable results for multiple runs with the same parameters. A mutation interval can be varied. In some implementations, the mutation interval is statically reduced three times during the optimization run in order to reduce the variance of the mutation with the optimization progress. The simple mutation operator is usually sufficient, but other operators (e.g. recombination), can also be used to produce the children.

In the FIG. 7 example, a (3,5)-strategy is used, i.e., there are 3 parents and 5 children, and the selection of the next parents is from the children only. In another implementation, weighting factors for fraud detection strategy rules are subjected to optimization according to a (5+13)-strategy as a default. This means that the next parents are selected by comparing the fitness of the 5 parents and the 13 children. In this variation, it is ensured that the best parents are not lost for the next iteration.

The maximum number of iterations/generations depends on the number of detection methods assignments (n) of the detection strategy, as the complexity increases by factor \sqrt{n} with the dimension of the optimization problem. The base parameter for the maximum number of generations can be set to 30 by default. The default configuration parameters of the genetic algorithm (μ, λ, max generations) have been validated by empiric test runs.

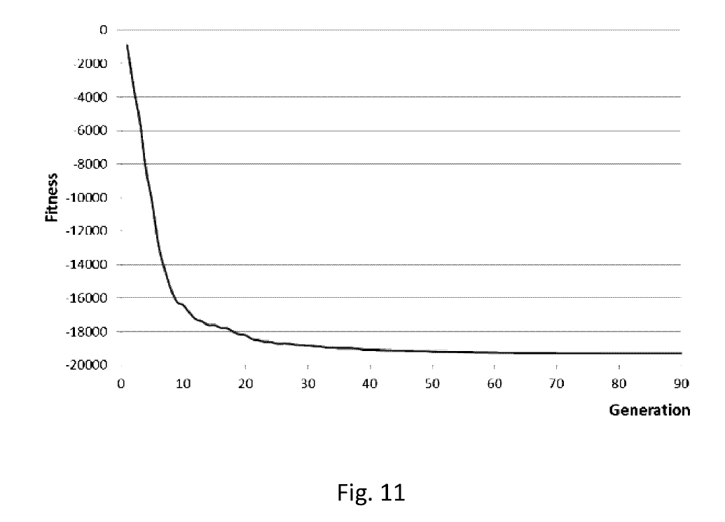

FIG. 11 shows the typical convergence of fitness function of the genetic algorithm over the generations for an exemplary implementation. The example of FIG. 11 is based on a detection strategy with nine detection method assignments (i.e., nine rules). As indicated, there is good progress toward a solution from the beginning until generation 10. From generation 10 until generation 40, progress slows. Convergence to the final value occurs at around generation 60.

The quality and convergence of the genetic algorithm heavily depends on the selection of the fitness function and the mathematic model of the optimization problem. The following mathematic symbols and functions are used:

n: Number of Detection Method Assignments

w: Vector of n weighting factors

x: Detection Object to be analyzed

T: Threshold

S(w;x): Aggregated score of detection object x with weighting factors w

Dᵢ(x): Detection Result in [0,1] of detection method i

kₛ: Stretch factor of sigmoid function

k_{Profit}: Profit factor of proven fraud cases

k_{Cost}: Cost factor of false positive cases

k_{wd}: Weight Decay factor

The detection process of classifying a detection object x (e.g. an insurance claim, a purchase order, or other type of record) as fraudulent is based on the comparison of the aggregated score S of the assigned detection methods with the threshold T:

$$z = g ( \underline{w} ; x ) = \frac{S ( \underline{w} ; x ) - T}{T} = {\sum }_{i = 1}^{n} {w}_{i} * {D}_{i} ( x ) - 1 , T = 1$$

The aggregated score is calculated by multiplying the detection result Di(x) of each assigned detection method with its weighting factor wi of the detection strategy. To simplify the internal calculations during the optimization, a normalized threshold of T=1 is used for all optimization runs. The threshold and the resulting weighting factors can be easily scaled to the threshold of the detection strategy after the optimization is finished.

The standard detection processes uses a kind of step function σ(z) and returns fraud, if the aggregated score is greater than the threshold:

$$σ ( z ) = \{ \begin{matrix}0 , & z \leq 0 \to No Fraud \\ 1 , & z > 0 \to Fraud\end{matrix}$$

The optimization needs to be able to additionally evaluate the strength of the fraud indication. This has the following advantages:

Continuous indication for the optimization algorithm on progress even if threshold is not reached

Better generalization of optimization result for future detection objects to be analyzed

Therefore, the step function σ(z) is replaced with the sigmoid function sig(z;kₛ) for the optimization:

$$sig ( z ; {k}_{s} ) = \frac{1}{1 + {e}^{- {k}_{s} * z}}$$

The factor ks can be used to stretch the standard sigmoid function. The factor ks=5 has shown good results in test runs and is used as default configuration.

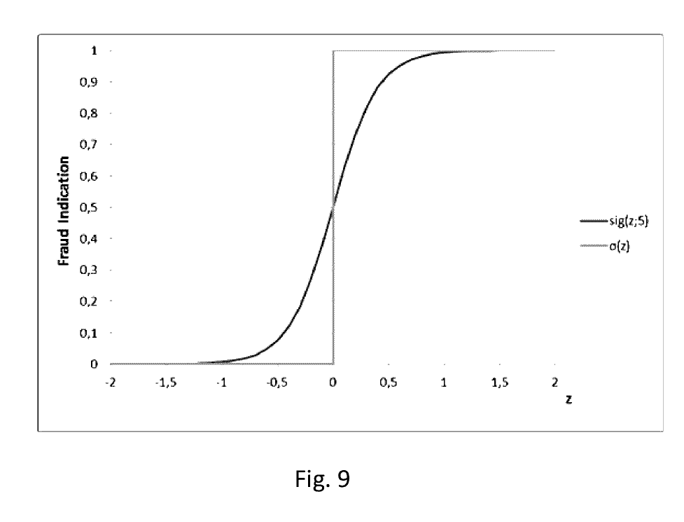

FIG. 9 shows a comparison of the fraud indication by the discrete function σ(z) used by the usual detection processes and the continuous function sig(z;5) used by the optimization. Both functions converge to 0 (->no fraud) for low scores and 1 (->fraud) for high scores compared to the threshold. However, the continuous function additionally gives an indication about the distance for scores close to the threshold.

Fraud detection is used across different industries and sectors with different requirements concerning its management. In insurance, it might be acceptable to miss some fraud cases in order to manage the workload on the investigators carefully. However, in compliance scenarios, companies usually cannot accept missing even a single fraud case. Therefore, an optimization purely on the efficiency is not sufficient, as it does not consider the missed fraud cases appropriately. Hence, the optimization target needs to be parameterized according to the business analysts' needs and industry. In the insurance context, the business analyst can use the profit factor k_{Profit} and the cost factor k_{Cost} to parameterize the profit of a proven fraud case compared to the costs of a false positive case.

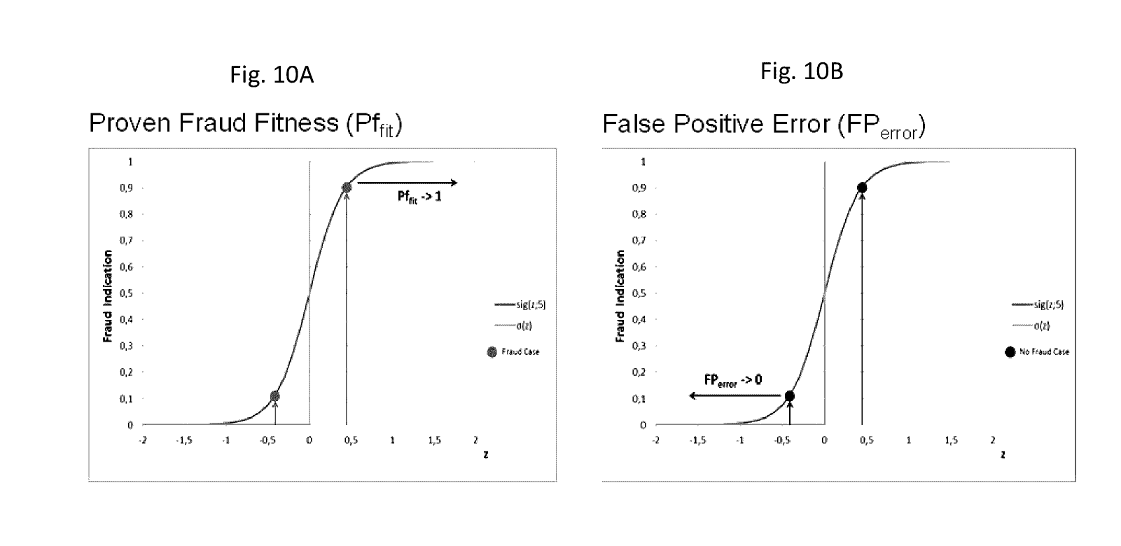

As shown in FIGS. 10A and 10B, the sigmoid function is used to calculate Proven Fraud Fitness (PFfit) and the False Positive Error (FPerror) from the raw simulation results of a detection strategy. Each fraud case returns a PFfit value and each no fraud case returns an FPerror value for a set of weighting factors w.

Proven Fraud Cases evaluated with the sigmoid function are converging to the discrete PF KPI of 1 with high scores. Missed fraud cases are converging to the discrete PF KPI of 0 with low scores.

False Positive Cases evaluated with the sigmoid function are converging to the discrete FP KPI of 1 with high scores. True negative cases are converging to the discrete FP KPI of 0 with low scores.

The fitness function of the optimization uses a combination of the continuous PFfit and FPerror values:

$$\overbrace{{PF}_{fit}} \overbrace{{FP}_{error}}$$

$$fit ( \underline{w} ; {k}_{s} ) = {k}_{Profit} * {\sum }_{x ∈ P} sig ( g ( \underline{w} ; x ) ; {k}_{s} ) - {k}_{Cost} * {\sum }_{x ∈ NF} sig ( g ( \underline{w} ; x ) ; {k}_{s} )$$

The optimization tries to place the fraud cases with a high score above threshold by maximizing the PFfit value. Similarly, the optimization tries to minimize the FPerror by classifying the no fraud cases with a low score. Therefore, the overall fitness function is maximized by considering the factors kProfit and kCost given by the end user. Technically, the negative fitness function is minimized in order to solve a minimization problem with optimization algorithm.

If the optimization is running for many generations, the fitness function can be slightly improved by pushing the weighting factors to high positive or negative values. However, the real fraud detection result does not improve anymore. Therefore, the weight decay (wd) to penalize high weighting factors is added to the fitness function:

$$wd = \frac{{k}_{wd}}{n} * {\sum }_{i = 1}^{n} {w}_{i}^{2}$$

The weight decay uses the typical quadratic error of the weighting factors. The weight decay is normalized with the number of assigned detection methods n that are aggregated during the weight decay calculation. The weight decay is additionally normalized with weight decay factor kwd which is by default set to 1/100 of the calculated proven fraud fitness value.

The advantages of adding the weight decay include improving generalization for future detection objects, avoiding over-fitting on the historically classified alert items and/or improving convergence of optimization runs.

The implementation of the genetic algorithm is located in class CL_FRA_OPT_GENETIC in package FRA_CALIBRATION. The class implements the IF_FRA_OPT_METHOD interface which is used by the Optimization Manager 222 to call the algorithm at runtime. The implementation requires the method OPTIMIZE which returns a set of optimized weighting factors for the profit and cost factors given by the end user.

The interface IF_{—} FRA_{—} OPT_HDB_ACCESS is used to access the raw calibration results of the detection strategy in the database 218. The raw results are already calculated before the algorithm is executed. The method CALCULATE_SIGMOID calculates the continuous PFfit and FPerror values for a set of weighting factors w. Furthermore, the method GET_CLASSIFIED_ALERTS is called to get the number of classified fraud and no fraud cases within the raw calibration results. This information is used by the genetic algorithm in method CHECK_CLASSIFIED_ALERTS to check the minimum number of classified fraud cases for the optimization. The default setting requires at least 10*n classified fraud cases. This helps to reduce an over-fitting based on a very small number of classified data.

The starting generation of parents is created in method CREATE_START_PARENTS. These μ parent solutions are created via the usual mutation operation on the initial weighting factors. The initial weighting factors are initialized with value 1/n for each detection method in method CALC_START_WF.

After the optimization with the genetic algorithm is finished, an adaptation of the resulting threshold and weighting factors might be required. The calibration UI is only capable to show weighting factors between −100 and 100. If one of the optimized weighting factors is outside the valid interval, the threshold and weighting factors need to be scaled accordingly in method NORMALIZE_RESULT.

The weighting factor optimization is expected to work at the customer side without any additional configuration via the delivered default settings. However, there might be scenarios that require an adaptation of the default settings. It is very difficult to validate the optimization algorithm in different customer-like scenarios with real classified data during development. Hence, there is the possibility to override the default settings for a specific detection strategy.

It is also possible to implement a dynamic adaptation of the mutation interval via the success rate of previous mutation steps. Further, additional supportability functions (discrete KPIs (PF, FP) for each iteration, success rate) can be added. Implementations can be configured to avoid optimizing detection method assignments without any result at all. Classified data can be split into training and validation sets to avoid over-fitting and improve generalization on future detection objects. In some implementations, there are flexible criteria to stop an optimization routine before the maximum generations are reached.

### Exemplary Computing Systems

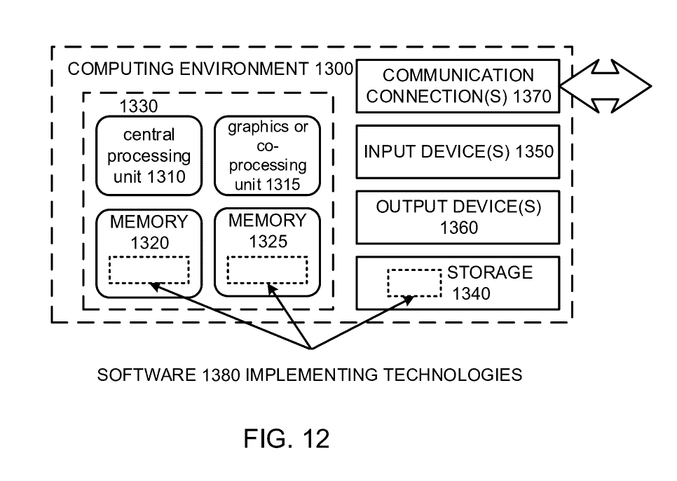

As described, the system and methods allow the investigator to use historic data to develop a strategy that yields appropriate results for use on current data. FIG. 12 illustrates a generalized example of a suitable computing system 1300 in which several of the described innovations may be implemented. The computing system 1300 is not intended to suggest any limitation as to scope of use or functionality, as the innovations may be implemented in diverse general-purpose or special-purpose computing systems.

With reference to FIG. 12, the computing system 1300 includes one or more processing units 1310, 1315 and memory 1320, 1325. In FIG. 12, this basic configuration 1330 is included within a dashed line. The processing units 1310, 1315 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 12 shows a central processing unit 1310 as well as a graphics processing unit or co-processing unit 1315. The tangible memory 1320, 1325 may be volatile memory (e.g., registers, cache, RAM), nonvolatile memory (e.g., ROM, EEPROM, flash memory, etc.), or some combination of the two, accessible by the processing unit(s). The memory 1320, 1325 stores software 1380 implementing one or more innovations described herein, in the form of computer-executable instructions suitable for execution by the processing unit(s).

A computing system may have additional features. For example, the computing system 1300 includes storage 1340, one or more input devices 1350, one or more output devices 1360, and one or more communication connections 1370. An interconnection mechanism (not shown) such as a bus, controller, or network interconnects the components of the computing system 1300. Typically, operating system software (not shown) provides an operating environment for other software executing in the computing system 1300, and coordinates activities of the components of the computing system 1300.

The tangible storage 1340 may be removable or non-removable, and includes magnetic disks, magnetic tapes or cassettes, CD-ROMs, DVDs, or any other medium which can be used to store information in a non-transitory way and which can be accessed within the computing system 1300. The storage 1340 stores instructions for the software 380 implementing one or more innovations described herein.

The input device(s) 1350 may be a touch input device such as a keyboard, mouse, pen, or trackball, a voice input device, a scanning device, or another device that provides input to the computing system 1300. For video encoding, the input device(s) 1350 may be a camera, video card, TV tuner card, or similar device that accepts video input in analog or digital form, or a CD-ROM or CD-RW that reads video samples into the computing system 1300. The output device(s) 1360 may be a display, printer, speaker, CD-writer, or another device that provides output from the computing system 1300.

The communication connection(s) 1370 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### ALTERNATIVES

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A computer-implemented fraud detection method for determining potentially fraudulent records in a database, comprising:
executing a trial fraud detection strategy routine on historic records in the database; the trial detection strategy comprising multiple rules;
calculating a number of the historic records determined to be proven fraud records according to the trial fraud detection strategy;
calculating a number of the historic records determined to be false positive records according to the trial fraud detection strategy;
calculating a trial efficiency of the trial fraud detection strategy based on a difference between a number of determined proven fraud records multiplied by a profit factor for each proven fraud record and a number of determined false positive records multiplied by a cost factor for each false positive record; and
determining an adjusted fraud detection strategy with an efficiency that equals or exceeds the trial efficiency.

2. The method of claim 1, wherein at least one of the multiple rules has a respective weighting factor, and wherein determining an adjusted fraud detection strategy comprises optimizing a weighting factor for the at least one of the multiple rules.

3. The method of claim 1, wherein the multiple rules have respective weighting factors, and wherein determining an adjusted fraud detection strategy comprises using a genetic solution approach to determine adjusted weighting factors for the multiple rules such that the rules are weighted relative to each other differently in the adjusted fraud detection strategy than in the trial fraud detection strategy.

4. The method of claim 3, wherein the genetic solution approach comprises selecting five children derived by mutation from three parents, and selecting three next generation parents from the five children.

5. The method of claim 3, wherein the genetic solution approach comprises selecting five children derived by mutation from three parents, and selecting three next generation parents from the five children, wherein the three next generation parents are selected from the five children based on the results of a fitness function.

6. The method of claim 3, wherein the genetic solution approach is iterated at least three times in determining the adjusted fraud detection strategy.

7. The method of claim 1, wherein the trial fraud detection strategy is executed once, and wherein determining an adjusted fraud detection strategy comprises selecting subsets of the results from the trial fraud detection strategy results and weighting each selected subset according to a predetermined method.

8. The method of claim 1, wherein the multiple rules comprise respective multiple weighting factors, and wherein determining an adjusted fraud detection strategy comprises iteratively comparing different combinations of the multiple weighting factors against each other via a fitness function.

9. The method of claim 1, wherein determining the adjusted fraud detection strategy comprises using a fitness function to determine the adjusted weighting factor.

10. The method of claim 1, further comprising querying the user to enter the profit factor and the cost factor.

11. A computer-implemented fraud detection system, comprising:
a processor;
memory storing computer-readable instructions for causing a computer to perform a method for determining potentially fraudulent records, the method comprising:
executing a trial fraud detection strategy routine on historic records in a database, the trial detection strategy comprising multiple rules including at least one weighting factor;
calculating an efficiency of the trial fraud detection strategy based on the multiple rules;
executing an iterative routine to optimize adjusting the at least one weighting factor;
setting an adjusted fraud detection strategy that incorporates the adjusted weighting factor.

12. The system of claim 11, wherein the method comprises calculating a number of the historic records determined to be proven fraud records according to the trial fraud detection strategy and calculating a number of the historic records determined to be false positive records according to the trial fraud detection strategy, and wherein calculating an efficiency of the trial fraud detection strategy comprises calculating the number of determined proven fraud records multiplied by a profit factor for each proven fraud record minus the number of determined false positive records multiplied by a cost factor for each false positive record.

13. The system of claim 11, wherein the multiple rules comprise at least one threshold.

14. The system of claim 11, wherein the multiple rules comprise at least two parameters and a respective at least two weighting factors for the at least two parameters.

15. The system of claim 11, wherein the method comprises receiving input from a user to calibrate a fraud detection strategy.

16. The system of claim 11, further comprising an interface component controlled by the processor to display a graphical user interface with information for the user, prompts for user inputs and results.

17. The system of claim 15, wherein the user interface prompts the use to enter a profit factor and a cost factor.

18. One or more computer-readable storage media comprising computer-executable instructions for performing a method of detecting fraudulent records in a database, comprising:
executing a trial fraud detection strategy routine on historic records in the database;
the trial detection strategy comprising multiple rules;
calculating a number of the historic records determined to be proven fraud records according to the trial fraud detection strategy;
calculating a number of the historic records determined to be false positive records according to the trial fraud detection strategy;
calculating a trial efficiency of the trial fraud detection strategy based on a difference between a number of determined proven fraud records multiplied by a profit factor for each proven fraud record and a number of determined false positive records multiplied by a cost factor for each false positive record; and
determining an adjusted fraud detection strategy with an efficiency that equals or exceeds the trial efficiency.

19. The one or more computer-readable storage media of claim 18, wherein at least one of the multiple rules has a respective weighting factor, and wherein determining an adjusted fraud detection strategy comprises optimizing a weighting factor for the at least one of the multiple rules.

20. The one or more computer-readable storage media of claim 18, wherein determining the adjusted fraud detection strategy comprises using a genetic solution approach to determine the weighting factor for the at least one of the multiple rules.
